(19) United States
(12) Patent Application Publication
(10) Pub. No.: US 2020/0050431 A1
(43) Pub. Date: Feb. 13, 2020

(54) RECOMMENDING DEVELOPMENT TOOL EXTENSIONS BASED ON USAGE CONTEXT TELEMETRY

(71) Applicant: Microsoft Technology Licensing, LLC, Redmond, WA (US)

(72) Inventors: Roshanak ZILOUCHIAN MOGHADDAM, Kirkland, WA (US); Kai-Uwe MAETZEL, Seattle, WA (US); Ramya Achutha RAO, Redmond, WA (US)

(21) Appl. No.: 16/058,931

(22) Filed: Aug. 8, 2018

(51) Int. Cl. G06F 8/33; G06F 8/38; G06F 8/77; G06F 11/34

(52) U.S. Cl. CPC G06F 8/33; G06F 8/38; G06F 8/75; G06F 11/3438; G06F 8/77

(57) ABSTRACT

Extensions to add functionality to an extensible computing technology development tool are identified and recommended to developers based at least in part on which tool extensions are being intensively used by developers working in the same or similar usage contexts. Usage contexts are specified in terms of projects, workspaces, repositories, and optionally their branches, forks, clones, or remotes, for example. Telemetry data voluntarily provided from developer systems is gathered and processed at a backend system to produce a data structure listing some top (in terms of use) tool extensions. This data structure is provided to developer systems, to serve as a basis for automatically recommending top tool extensions to developers, e.g., when they open a project or a workspace. This automatic recommendation relieves developers of the burden of researching extensions to try and choose the ones most likely to help them efficiently and effectively develop implementations of computing technology.

### BACKGROUND

Noon Software and computing hardware are created, tested, feature enhanced, corrected, performance optimized, and otherwise developed using computing technology development tools. Familiar functions of such development tools include text editing functions, design functions, syntax checking, source code completion, automatic and computer-assisted code generation, compiling, executable building, defect detection and debugging, provisioning and deployment, circuit layout, diagnostics, programming, and performance monitoring and profiling, for example. Computing technology development tools partially or fully automate such functions, in order to improve developer productivity and reduce downtime or time-to-market. Some development tools are stand-alone programs, while other development tools are provided in a suite for coordinated usage, such as an integrated development environment. Some development tools are tailored to one or more particular programming languages while other tools, or at least portions thereof, are programming language agnostic, meaning they do not rely on or take advantage of features that are specific to a particular programming language. Widely used development tools may have thousands of available extensions, each with its own features, limitations, and operational assumptions or options.

### SUMMARY

Some computing technology development tools are tailored to interoperate with tool extensions, which add functionality to the development tool. Some development tool extensions are available through public or private tool extension marketplaces. Some teachings herein were motivated by an initial technical challenge of rapidly providing an optimized work environment to a developer who has cloned a repository. A subordinate challenge was identifying relevant development tool extensions from among a large and growing body of development tool extensions, and informing software developers that the relevant tool extensions were available and why the tool extensions are deemed relevant. Similar considerations apply to hardware development tools which are implemented with software. Other technical challenges addressed by the innovations taught here will also be apparent to one of skill from the discussion provided below.

Some recommendation backend embodiments include a processor, and a memory in operable communication with the processor. The backend operates on tool extension usage data which includes at least the following: (a) tool extension user identifications which identify users of one or more tool extensions, (b) tool extension identifications which identify one or more tool extensions which have been used by one or more of the users, and (c) tool extension usage context identifications which identify usage contexts in which tool extensions have been used by one or more of the users.

In these embodiments, an executable top-extensions-by-context computation code computes a top-extensions-by-context structure from at least part of the tool extension usage data. The top-extensions-by-context structure includes entries, with each entry naming a usage context and listing one or more tool extensions which the top-extensions-by-context computation code determines have been used intensively in that usage context. An executable recommendation code transmits at least a portion of the top-extensions-by-context structure onto a network connection toward at least one developer system, where other recommendation code receives it and displays it to a developer in a tool extension recommendation.

The top-extensions-by-context structure may configure the developer system for improved developer productivity by implementing a recommendation service which displays intensively used tool extensions to the developer, recommending their use in a usage context that is named in the top-extensions-by-context structure. Intensively used extensions are deemed more relevant than other extensions, and will help optimize the developer's working environment. By displaying at least part of a list of one or more intensively used tool extensions, these embodiments recommend tool extensions for use in the developer's current usage context. Partially or fully adopting the recommendation by installing and using the recommended extension(s) allows the developer to avoid expending developer time and developer system resources on efforts that would otherwise be needed to discover these helpful extensions.

In some embodiments, a development tool includes a user interface renderer which communicates with a tool extension via an agent, and in some cases the tool extension interfaces directly with an extension host, which may be remote from the renderer. The renderer and the host may be on the same machine, or on different machines, depending on the particular development tool implementation. More generally, an extensible development tool is configured to interoperate with development tool extensions that add functionality to the development tool.

Other technical activities pertinent to teachings herein will also become apparent to those of skill in the art. The examples given are merely illustrative. This Summary is not intended to identify key features or essential features of the claimed subject matter, nor is it intended to be used to limit the scope of the claimed subject matter. Rather, this Summary is provided to introduce—in a simplified form—some technical concepts that are further described below in the Detailed Description. The innovation is defined with claims, and to the extent this Summary conflicts with the claims, the claims should prevail.

### DESCRIPTION OF THE DRAWINGS

A more particular description will be given with reference to the attached drawings. These drawings only illustrate selected aspects and thus do not fully determine coverage or scope.

FIG. 1 is a block diagram illustrating a computer system and also illustrating a configured storage medium;

FIG. 2 is a block diagram illustrating aspects of a computing technology development environment which includes a developer system with a development tool, an extension marketplace with development tool extensions, and a tool extension recommendation backend system;

FIG. 3 is a block diagram illustrating aspects of a development tool according to some development tool architectures, including a user interface renderer, and also including one or more extensions in an extension host;

FIG. 4 is a block diagram illustrating aspects of a development tool system according to some development tool architectures which include a developer machine with a user interface renderer, and also include an extension machine with an agent and with one or more extensions in an extension host;

FIG. 5 is a diagram illustrating two operating environments for a virtual machine;

FIG. 6 is a block diagram illustrating aspects of some tool extension usage data;

FIG. 7 is a block diagram illustrating aspects of an entry of a top-extensions-by-context data structure;

FIG. 8 is a block diagram illustrating some specifiers which may define a usage context for a development tool extension;

FIG. 9 is a block diagram illustrating some aspects of a code which computes a top-extensions-by-context data structure;

FIG. 10 is a block diagram illustrating some criteria for determining whether a tool extension has been intensively used;

FIG. 11 is a flowchart illustrating some example development tool extension recommendation methods;

FIG. 12 is a diagram illustrating some examples of resource expenditures that can be partially or fully avoided using a FIG. 11 method; and

FIG. 13 is a flowchart further illustrating steps in some development tool extension recommendation methods.

### DETAILED DESCRIPTION

Overview

Many innovations expand beyond their origins, but understanding an innovation's origins can help one more fully appreciate the innovation. In the present case, innovations in tool extension recommendation arose in the context of the inventors seeking ways to improve the usability of a software development tool known in the industry as “VS Code”. The name “VS Code” refers to versions of a software development tool known as Visual Studio® Code (mark of Microsoft Corporation). “Visual Studio® Code” is abbreviated herein as “VS Code”. VS Code implementations use a multi-process architecture which includes at least a user interface renderer process and an extension host process.

VS Code architecture and usage provide informative examples in this document. However, one of skill will acknowledge that the teachings provided herein are not all limited to VS Code environments. Many of the teachings may also or alternatively be applied to enhance development work that employs other computing technology development tools.

One of the capabilities of many development tools is text editing. The text being edited is often computer program source code, which may be kept in a repository to facilitate collaboration between developers and to provide version control. Some of the most widely used web-based repositories, which provide services for source code and development project hosting, include GitHub® (mark of GitHub, Inc.), BitBucket® (mark of Atlassian Pty Ltd), and SourceForge® (mark of SourceForge Media, LLC). However, many other kinds of repository also exist, and many individual repositories and repository services may be created after the filing of the present disclosure.

A developer may “clone” a repository, that is, make a copy of a particular project or other item stored in a repository in order to work on or with that item. In con junction with such cloning, the developer faces the challenge of obtaining or creating a working environment in which to work on the clone. With some development tools, including many versions of VS Code software, a developer's working environment largely depends on the tool extensions that have been installed. For example, the VS Code renderer process is programming language agnostic, so programming language support is built into VS Code extensions and accessed through the extension host process.

Thousands of VS Code extensions exist, and other development tools may also have a large number of extensions. Some extensions may be easily ruled out as unsuitable for a given development project, e.g., because they are tailored to a programming language that is not being used in the project. But the developer often still faces the challenge of somehow making good tool extension choices from among dozens or hundreds of nominally suitable extensions.

Sifting through available extensions manually or even with the assistance of a query interface may involve significant expenditure of developer time, and may consume computational resources such as memory space, processing cycles, and network bandwidth. Time and resources could be spent querying an extension marketplace using keywords to produce a list of extensions, but that effort will not necessarily tell the developer whether other similarly situated developers have found the listed extensions to be useful. Online publications could be searched, such as blogs, forum discussions, periodical articles, technical papers, and even marketing materials touting particular tool extensions. But that kind of research can consume significant developer time, and it will not necessarily yield actionable information about tool extensions that are relevant to the project at hand. The developer could survey other developers, including colleagues working on the project in question, to see what they suggest. The survey could be conducted by phone, or email, or even using online survey services. But drafting the survey, distributing it, gathering responses, reminding fellow developers to submit their response, and analyzing the responses all would take developer time and computational resources.

Teachings presented herein provide an attractive alternative. Technology taught herein makes very efficient use of developer time, without imposing substantial resource costs, to help developers obtain an optimized working environment quickly and easily. The technology automatically tracks usage of tool extensions in conjunction with different repositories, and processes the resulting data to generate recommendations which highlight tool extensions that have been intensively used by similarly situated developers. In short, tool extension recommendations based on telemetry are computed and provided.

For example, for each root folder in a VS Code workspace, the technology tracks git remotes of the folder and extension activations, via telemetry sent from developer systems to a backend system. Extension recommendation code on the backend system processes the telemetry data, e.g., by computing a transitive closure of all remotes that represent the same repository. For each such closure class, the backend computes which extensions have been activated by how many distinct users. Findings that are deemed insufficiently significant are discarded, e.g., one approach only counts remotes that have at least 250 users. The resulting information about intensively used extensions is sent to the developer systems. When a developer opens a workspace on a particular developer system, the enhanced VS Code software proposes the most popular non-installed extensions for use with the workspace's repositories. Other tools may be similarly adapted to recommend intensively used and highly relevant extensions.

Some embodiments described herein may be viewed by some people in a broader context. For instance, concepts such as context, development, extension, recommendation, similarity, and tracking may be deemed relevant to a particular embodiment. However, it does not follow from the availability of a broad context that exclusive rights are being sought herein for abstract ideas; they are not. Rather, the present disclosure is focused on providing appropriately specific embodiments whose technical effects fully or partially solve particular technical problems, such as how to efficiently recommend tool extensions that tend to make development more productive. Other configured storage media, systems, and methods involving context, development, extension, recommendation, similarity, or tracking are outside the present scope. Accordingly, vagueness, mere abstractness, lack of technical character, and accompanying proof problems are also avoided under a proper understanding of the present disclosure.

Technical Character

The technical character of embodiments described herein will be apparent to one of ordinary skill in the art, and will also be apparent in several ways to a wide range of attentive readers. Some embodiments address technical activities that are rooted in computing technology and improve the functioning of computing systems by helping those systems make more extensive use of relevant development tool extensions. The tool extensions that are used on a developer system become, in functional effect, a part of that system. By operation of the recommendation mechanisms and techniques taught herein, developer systems will be improved because “better” tool extensions will tend to be recommended and employed over time. In this context, a tool extension X is “better” than a tool extension Y when X is easier than Y for developers to operate, has fewer bugs than Y, has greater functionality than Y, performs a desired or frequent operation faster than Y or using less memory than Y, is more secure than Y, or interoperates more effectively with other software than Y, for example, or has multiple such advantages over Y.

Technical effects provided by some embodiments include increased use of better tool extensions, with corresponding technical effects such as easier operation, increased accuracy, improved speed, reduced memory usage, and so on. Embodiments also promote broader availability of highly relevant development tool extensions, such as extensions that have been used frequently by developers working on the same or similar repositories.

Some embodiments include technical adaptations such as top-extensions-by-context code and structures, usage context specifiers, transitive closures, and intensive use criteria.

Other advantages based on the technical characteristics of the teachings will also be apparent to one of skill from the description provided.

### Acronyms, Abbreviations, and Names

Some acronyms, abbreviations, and names are defined below. Others are defined elsewhere herein, or do not require definition here in order to be understood by one of skill.

ALU: arithmetic and logic unit

API: application program interface

ASCII: American Standard Code for Information Interchange

BIOS: basic input/output system

CD: compact disc

CPU: central processing unit

DAP: debug adapter protocol

DVD: digital versatile disk or digital video disc

FPGA: field-programmable gate array

FPU: floating point processing unit

GPU: graphical processing unit

GUI: graphical user interface

HTML: hypertext markup language

HTTP: hypertext transfer protocol

HTTPS: hypertext transfer protocol secure

IDE: integrated development environment, sometimes also called “interactive development environment”

IP: internet protocol

Java: programming language

LAN: local area network

LSP: language server protocol

OS: operating system

RAM: random access memory

ROM: read only memory

TCP/IP: transmission control protocol/internet protocol

UDP: user datagram protocol

VS Code: Visual Studio® Code program (mark of Microsoft Corp.)

WAN: wide area network

### Additional Terminology

Reference is made herein to exemplary embodiments such as those illustrated in the drawings, and specific language is used herein to describe the same. But alterations and further modifications of the features illustrated herein, and additional technical applications of the abstract principles illustrated by particular embodiments herein, which would occur to one skilled in the relevant art(s) and having possession of this disclosure, should be considered within the scope of the claims.

The meaning of terms is clarified in this disclosure, so the claims should be read with careful attention to these clarifications. Specific examples are given, but those of skill in the relevant art(s) will understand that other examples may also fall within the meaning of the terms used, and within the scope of one or more claims. Terms do not necessarily have the same meaning here that they have in general usage (particularly in non-technical usage), or in the usage of a particular industry, or in a particular dictionary or set of dictionaries. Reference numerals may be used with various phrasings, to help show the breadth of a term. Omission of a reference numeral from a given piece of text does not necessarily mean that the content of a Figure is not being discussed by the text. The inventors assert and exercise the right to specific and chosen lexicography. Quoted terms are being defined explicitly, but a term may also be defined implicitly without using quotation marks. Terms may be defined, either explicitly or implicitly, here in the Detailed Description and/or elsewhere in the application file.

As used herein, a “computer system” may include, for example, one or more servers, motherboards, processing nodes, laptops, tablets, personal computers (portable or not), personal digital assistants, smartphones, smartwatches, smartbands, cell or mobile phones, other mobile devices having at least a processor and a memory, video game systems, augmented reality systems, holographic projection systems, televisions, wearable computing systems, and/or other device(s) providing one or more processors controlled at least in part by instructions. The instructions may be in the form of firmware or other software in memory and/or specialized circuitry.

A “multithreaded” computer system is a computer system which supports multiple execution threads. The term “thread” should be understood to include any code capable of or subject to scheduling (and possibly to synchronization), and may also be known by another name, such as “task,” “process,” or “coroutine,” for example. The threads may run in parallel, in sequence, or in a combination of parallel execution (e.g., multiprocessing) and sequential execution (e.g., time-sliced).

A “processor” is a thread-processing unit, such as a core in a simultaneous multithreading implementation. A processor includes hardware. A given chip may hold one or more processors. Processors may be general purpose, or they may be tailored for specific uses such as vector processing, graphics processing, signal processing, floating-point arithmetic processing, encryption, I/O processing, and so on.

“Kernels” include operating systems, hypervisors, virtual machines, BIOS code, and similar hardware interface software.

“Code” means processor instructions, data (which includes constants, variables, and data structures), or both instructions and data. “Code” and “software” are used interchangeably herein. Executable code, interpreted code, and firmware are some examples of code. Code which must be interpreted or compiled in order to execute is referred to as “source code”.

“Program” is used broadly herein, to include applications, kernels, drivers, interrupt handlers, firmware, state machines, libraries, and other code written by programmers (who are also referred to as developers) and/or automatically generated.

“Service” means a consumable program offering in a cloud computing environment or other network or computing system environment.

“Cloud” means pooled resources for computing, storage, and networking which are elastically available for measured on-demand service. A cloud may be private, public, community, or a hybrid, and cloud services may be offered in the form of infrastructure as a service, platform as a service, software as a service, or another service. Unless stated otherwise, any discussion of reading from a file or writing to a file includes reading/writing a local file or reading/writing over a network, which may be a cloud network or other network, or doing both (local and networked read/write).

As used herein, “include” allows additional elements (i.e., includes means comprises) unless otherwise stated.

“Optimize” means to improve, not necessarily to perfect. For example, it may be possible to make further improvements in a program or an algorithm which has been optimized.

“Process” is sometimes used herein as a term of the computing science arts, and in that technical sense encompasses resource users, namely, coroutines, threads, tasks, interrupt handlers, application processes, kernel processes, procedures, and object methods, for example. “Process” is also used herein as a patent law term of art, e.g., in describing a process claim as opposed to a system claim or an article of manufacture (configured storage medium) claim. Similarly, “method” is used herein at times as a technical term in the computing science arts (a kind of “routine”) and also as a patent law term of art (a “process”). Those of skill will understand which meaning is intended in a particular instance, and will also understand that a given claimed process or method (in the patent law sense) may sometimes be implemented using one or more processes or methods (in the computing science sense).

“Automatically” means by use of automation (e.g., general purpose computing hardware configured by software for specific operations and technical effects discussed herein), as opposed to without automation. In particular, steps performed “automatically” are not performed by hand on paper or in a person's mind, although they may be initiated by a human person or guided interactively by a human person. Automatic steps are performed with a machine in order to obtain one or more technical effects that would not be realized without the technical interactions thus provided.

One of skill understands that technical effects are the presumptive purpose of a technical embodiment. The mere fact that calculation is involved in an embodiment, for example, and that some calculations can also be performed without technical components (e.g., by paper and pencil, or even as mental steps) does not remove the presence of the technical effects or alter the concrete and technical nature of the embodiment. Operations such as running a renderer, executing a tool extension, communicating between a developer system and a tool extension recommendation backend system, checking whether a tool extension is installed, forming a transitive closure, curating extension usage data, and pruning extension usage data are understood herein as inherently digital. A human mind cannot interface directly with a CPU or other processor, or with RAM or other digital storage, to read and write the necessary data to perform the extension environment tracking and extension recommendation steps taught herein. This would be well understood by persons of skill in the art in view of the present disclosure, but others may sometimes need to be informed or reminded of the facts. Unless stated otherwise, embodiments are also presumed to be capable of operating at scale (i.e., one thousand or more primary users) in production environments, or in testing labs for production environments, as opposed to being mere thought experiments.

“Computationally” likewise means a computing device (processor plus memory, at least) is being used, and excludes obtaining a result by mere human thought or mere human action alone. For example, doing arithmetic with a paper and pencil is not doing arithmetic computationally as understood herein. Computational results are faster, broader, deeper, more accurate, more consistent, more comprehensive, and/or otherwise provide technical effects that are beyond the scope of human performance alone. “Computational steps” are steps performed computationally. Neither “automatically” nor “computationally” necessarily means “immediately”. “Computationally” and “automatically” are used interchangeably herein.

“Proactively” means without a direct request from a user. Indeed, a user may not even realize that a proactive step by an embodiment was possible until a result of the step has been presented to the user. Except as otherwise stated, any computational and/or automatic step described herein may also be done proactively.

Throughout this document, use of the optional plural “(s)”, “(es)”, or “(ies)” means that one or more of the indicated features is present. For example, “processor(s)” means “one or more processors” or equivalently “at least one processor”.

For the purposes of United States law and practice, use of the word “step” herein, in the claims or elsewhere, is not intended to invoke means-plus-function, step-plus-function, or 35 United State Code Section 112 Sixth Paragraph/Section 112(f) claim interpretation. Any presumption to that effect is hereby explicitly rebutted.

For the purposes of United States law and practice, the claims are not intended to invoke means-plus-function interpretation unless they use the phrase “means for”. Claim language intended to be interpreted as means-plus-function language, if any, will expressly recite that intention by using the phrase “means for”. When means-plus-function interpretation applies, whether by use of “means for” and/or by a court's legal construction of claim language, the means recited in the specification for a given noun or a given verb should be understood to be linked to the claim language and linked together herein by virtue of any of the following: appearance within the same block in a block diagram of the figures, denotation by the same or a similar name, denotation by the same reference numeral, a functional relationship depicted in any of the figures, a functional relationship noted in the present disclosure's text. For example, if a claim limitation recited a “zac widget” and that claim limitation became subject to means-plus-function interpretation, then at a minimum all structures identified anywhere in the specification in any figure block, paragraph, or example mentioning “zac widget”, or tied together by any reference numeral assigned to a zac widget, or disclosed as having a functional relationship with the structure or operation of a zac widget, would be deemed part of the structures identified in the application for zac widgets and would help define the set of equivalents for zac widget structures.

Throughout this document, unless expressly stated otherwise any reference to a step in a process presumes that the step may be performed directly by a party of interest and/or performed indirectly by the party through intervening mechanisms and/or intervening entities, and still lie within the scope of the step. That is, direct performance of the step by the party of interest is not required unless direct performance is an expressly stated requirement. For example, a step involving action by a party of interest such as ascertaining, avoiding, calculating, checking, computing, connecting, communicating, configuring, creating, curating, debugging, determining, discerning, displaying, editing, executing, expending, finding, forming, identifying, indicating, joining, listing, locating, obtaining, opening, pruning, querying, receiving, recommending, rendering, running, searching, sending, specifying, surveying, using, utilizing (and ascertains, ascertained, avoids, avoided, etc.) with regard to a destination or other subject may involve intervening action such as forwarding, copying, uploading, downloading, encoding, decoding, compressing, decompressing, encrypting, decrypting, authenticating, invoking, and so on by some other party, yet still be understood as being performed directly by the party of interest.

Whenever reference is made to data or instructions, it is understood that these items configure a computer-readable memory and/or computer-readable storage medium, thereby transforming it to a particular article, as opposed to simply existing on paper, in a person's mind, or as a mere signal being propagated on a wire, for example. For the purposes of patent protection in the United States, a memory or other computer-readable storage medium is not a propagating signal or a carrier wave or mere energy outside the scope of patentable subject matter under United States Patent and Trademark Office (USPTO) interpretation of the In re Nuijten case. No claim covers a signal per se or mere energy in the United States, and any claim interpretation that asserts otherwise in view of the present disclosure is unreasonable on its face. Unless expressly stated otherwise in a claim granted outside the United States, a claim does not cover a signal per se or mere energy.

Moreover, notwithstanding anything apparently to the contrary elsewhere herein, a clear distinction is to be understood between (a) computer readable storage media and computer readable memory, on the one hand, and (b) transmission media, also referred to as signal media, on the other hand. A transmission medium is a propagating signal or a carrier wave computer readable medium. By contrast, computer readable storage media and computer readable memory are not propagating signal or carrier wave computer readable media. Unless expressly stated otherwise in the claim, “computer readable medium” means a computer readable storage medium, not a propagating signal per se and not mere energy.

An “embodiment” herein is an example. The term “embodiment” is not interchangeable with “the invention”. Embodiments may freely share or borrow aspects to create other embodiments (provided the result is operable), even if a resulting combination of aspects is not explicitly described per se herein. Requiring each and every permitted combination to be explicitly and individually described is unnecessary for one of skill in the art, and would be contrary to policies which recognize that patent specifications are written for readers who are skilled in the art. Formal combinatorial calculations and informal common intuition regarding the number of possible combinations arising from even a small number of combinable features will also indicate that a large number of aspect combinations exist for the aspects described herein. Accordingly, requiring an explicit recitation of each and every combination would be contrary to policies calling for patent specifications to be concise and for readers to be knowledgeable in the technical fields concerned.

### LIST OF REFERENCE NUMERALS

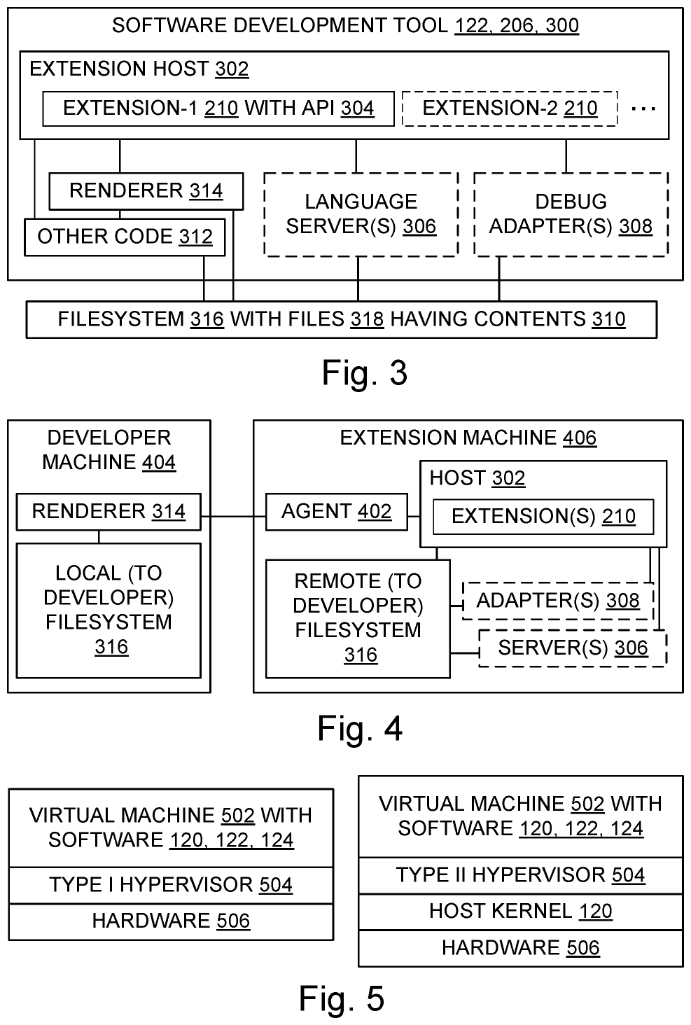

The following list is provided for convenience and in support of the drawing figures and as part of the text of the specification, which describe innovations by reference to multiple items. Items not listed here may nonetheless be part of a given embodiment. For better legibility of the text, a given reference number is recited near some, but not all, recitations of the referenced item in the text. The same reference number may be used with reference to different examples or different instances of a given item. The list of reference numerals is:
100 operating environment, also referred to as computing environment
102 computer system, also referred to as computational system or computing system
104 users
106 peripherals
108 network generally
110 processor
112 computer-readable storage medium, e.g., RAM, hard disks
114 removable configured computer-readable storage medium
116 instructions executable with processor; may be on removable storage media or in other memory (volatile or non-volatile or both)
118 data
120 kernel(s), e.g., operating system(s), BIOS, device drivers
122 tools, e.g., anti-virus software, firewalls, packet sniffer software, intrusion detection systems (IDS), intrusion prevention systems (IPS), software development tools and tool suites, hardware development tools and tool suites
124 applications, e.g., word processors, web browsers, spreadsheets, games, email tools
126 display screens, also referred to as “displays”
128 computing hardware not otherwise associated with a reference number 106, 108, 110, 112, 114
202 developer system
204 extension market; “market” and “marketplace” are used interchangeably herein
206 extensible computing technology development tool; may also be referred to as “computing technology development tool”, or “development tool”
208 extension market search interface; may be implemented, e.g., using one or more APIs
210 extension to a computing technology development tool; may also be referred to as a “plug-in” or “tool extension”; includes binary or other executable code; not to be confused with a filename extension such as “.doc” or “.pdf” or “.html”
212 query from developer system to extension market
214 query reply from extension market to developer system; also referred to as “query response” or “query result”
216 tool extension recommendation backend system; may also be referred to as “backend” or “backend system”
218 executable telemetry code
220 executable tool extension recommendation code; may also be referred to as “recommendation code”; may reside partially on backed system and partially on developer system in some embodiments
222 tool extension usage data; in raw form may also be referred to as “telemetry” or “telemetry data”; in non-raw (processed) form or raw form may be referred to as “usage data” or “extension usage data”
224 processed form of telemetry data, referred to as “top-extensions-by-context” data or structure
226 executable top-extensions-by-context code
228 tool extension recommendation, namely, all or part of top-extensions-by-context structure in human-readable format such as text displayed on a screen or in a file; it is contemplated that recommendations will generally be positive recommendations, e.g., along the lines of “Here is a list of extensions you should consider using because others have been using them.” But in some cases a recommendation may be negative, e.g., along the lines of “Are you sure you want to use that tool extension? Almost nobody else is using it.”
300 software development tool; this is an example of a computing technology development tool 206, which in turn is an example of a tool 122
302 software development tool extension host
304 software development tool extension API
306 programming language server, e.g., a Java language server, TypeScript server, Python server or other programming-language specific server
308 debug adapter, e.g., a Java language debug adapter or Python debug adapter or other programming-language-specific or debugger-specific or runtime-specific debug adapter
310 file contents
312 software development tool code not otherwise called out in FIG. 3; may include extension host communication agent, spawned processes, an additional extension host, a portion of recommendation code, or other code, for example
314 renderer portion of a software development tool; not to be confused with a rendering engine whose primary purpose is generating computer graphics, such as a ray tracing rendering engine or other image synthesis code which provides control over camera placement, light placement, shading, texture mapping, and other visual effects data; the renderer 314 renders a tool user interface typically used for viewing and editing source code text or similar file contents which is processed to produce executable software
316 filesystem, also sometimes referred to as “file system”; system software which controls how data is stored and retrieved; typically includes use of at least a filename and names of one or more directories in a hierarchy of directories; a filesystem path is used to locate the file so its contents can be read or written
318 computing technology development file, namely, a file containing data which is useful for software or hardware development
402 extension host communication agent
404 developer machine
406 extension machine
502 virtual machine
504 hypervisor
506 processor, memory, other hardware supporting virtual machine(s)
602 identification of tool extension user
604 identification of tool extension
606 tool extension usage context, e.g., project or repository or workspace or transitive closure including same
608 identification of tool extension usage context, may be implemented using, e.g., a globally unique identifier (GUID), uniform resource identifier (URI), handle, index, address, or other identifier
610 user activity data
700 entry in top-extensions-by-context structure, e.g., member, record, row, struct, object, item, or other portion of said structure
702 usage context name; may be the same as identification 608 of tool extension usage context or may be a human-friendly name or alias which corresponds to identification 608
704 list of intensively used tool extensions
800 specifiers of tool extension usage context
802 development project, also refers to name or other ID for a development project
804 computer program source code
806 repository; may hold computer program source code, object code, resource files, dynamic link libraries, and other components of computing technology manifestations that are under development; also refers to repository identifier
808 development tool workspace; also refers to repository identifier
810 fork (as part of or in reference to a usage context 606); also refers to fork identifier
812 branch (as part of or in reference to a usage context 606); also refers to branch identifier
814 clone (as part of or in reference to a usage context 606); also refers to clone identifier
816 remote (as part of or in reference to a usage context 606); also refers to remote identifier
818 transitive closure, namely, a component of a usage context 606 and all related items under a given specification of transitive closure—a given component may have different transitive closures depending on the specification, e.g., a transitive closure of a repository may have different content depending on whether the transitive closure specification includes or excludes forks of the repository; also refers to transitive closure identifier
820 transitive closure specification
902 executable code to curate tool extension usage data
904 executable code to prune tool extension usage data
906 dedicated user; this is a user 104 who meets additional criteria such as appearing in the tool extension usage data at least a specified number of times, e.g., more than once, or more than twice, or more than N times
908 executable code to discern dedicated users from tool extension usage data
910 executable code to form a transitive closure 818 based on an implicit or explicit specification 820
1000 examples of criteria which indicate intensive use of a tool extension
1002 extension in question has been used at least M times, where integer M>0
1004 extension in question has been used by at least M distinct users, where integer M>0
1006 extension in question has been used by at least M percent of active users (users identified in the usage data as using at least one extension), where 100>=M>0
1008 extension in question has been invoked (used) M times and M is one of the top N highest invocation counts for this usage data, where integer M>0, integer N>0
1010 extension in question has been invoked (used) by M distinct users and M is one of the top N highest user counts for this usage data, where integer M>0, integer N>0
1012 extension in question has been invoked (used) M times and M is one of the top N highest invocation counts for recent usage data, where integer M>0, integer N>0, and recent usage data includes only invocations within a specified recent period of time, e.g., past hour, past 6 hours, past day, past 3 days, past week, past two weeks, past month, etc.
1014 any intensive use criteria not otherwise specifically called out in FIG. 10
1100 flowchart; also refers to method(s) illustrated by the flowchart
1102 obtain data about tool extension usage, e.g., telemetry data
1104 compute a top-extensions-by-context structure based on data 222
1106 display, e.g., on a screen 126 or in a file, a list of intensively used tool extensions, based on the top-extensions-by-context structure, e.g., display extensions named in first three entries of structure 224
1108 avoid expending computational resources to identify intensively used tool extensions by query 1202 or survey 1210, etc.
1110 expend computational resources to identify intensively used tool extensions by query 1202 or survey 1210, etc.
1112 utilize one or more tool extensions displayed 1106 in recommendation 228
1202 query a tool extension market by keyword or tag
1204 search blogs, forums, or online discussion by developers
1206 search technical journals or periodicals
1208 search tool or tool extension marketing materials
1210 survey developers
1300 flowchart; also refers to method(s) illustrated by the flowchart
1302 send extension usage data over a network connection toward another system
1304 receive extension usage data over a network connection from another system
1306 check whether a tool extension is installed on a developer system
1308 perform computations and form a transitive closure
1310 open a tool extension usage context, e.g., open a workspace, open a project, access a repository
1312 locate a usage context (or its identifier) in a data structure 224
1314 indicate to a user, e.g., in a graphical user interface or other user interface, that a particular tool extension has been installed
1316 install a tool extension
1318 avoid including (naming, listing, displaying, etc.) a tool extension in a list of tool extensions
1320 curate tool extension usage data as taught herein
1322 prune tool extension usage data as taught herein
1324 calculate activation frequencies for tool extensions
1326 activation frequencies for tool extensions
1328 create a lookup table 1332
1330 use a lookup table 1332
1332 lookup table memorializing intensively used tool extensions
1334 discern dedicated users based on usage data
1336 any other step discussed herein but not specifically called out in FIG. 13
1338 ascertain which tool extensions a developer has used (e.g., invoked or loaded for use) in a given activity session
1340 activity session, e.g., period between developer login and logout
1342 join usage context activity data and tool extension data to determine which tool extensions were used in which usage contexts
1344 determine which tool extensions were used in which usage contexts; also refers to resulting determination
1346 find which usage context(s) a given user was active in, based on the usage data

Operating Environments

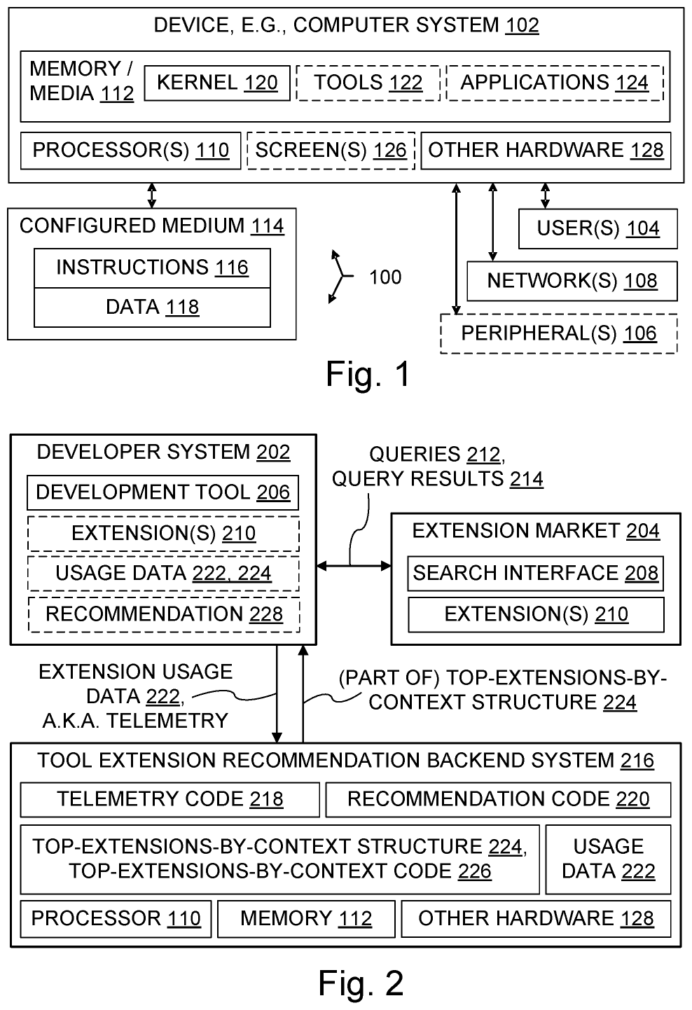

With reference to FIG. 1, an operating environment 100 for an embodiment includes at least one computer system 102. The computer system 102 may be a multiprocessor computer system, or not. An operating environment may include one or more machines in a given computer system, which may be clustered, client-server networked, and/or peer-to-peer networked within a cloud.

An individual machine is a computer system, and a group of cooperating machines is also a computer system. A given computer system 102 may be configured for end-users, e.g., with applications, for administrators, as a server, as a distributed processing node, and/or in other ways.

Human users 104 may interact with the computer system 102 by using displays, keyboards, and other peripherals 106, via typed text, touch, voice, movement, computer vision, gestures, and/or other forms of I/O. A screen 126 may be a removable peripheral 106 or may be an integral part of the system 102. A user interface may support interaction between an embodiment and one or more human users. A user interface may include a command line interface, a graphical user interface (GUI), natural user interface (NUI), voice command interface, and/or other user interface (UI) presentations, which may be presented as distinct options or may be integrated.

System administrators, network administrators, software developers, hardware developers, engineers, and end-users are each a particular type of user 104, although it is contemplated that most users will likely be software developers who are end-users of a software development tool. Automated agents, scripts, playback software, and the like acting on behalf of one or more people may also be users 104, e.g., to facilitate testing a system 102, but end-users are people (not processes) unless clearly indicated otherwise. Storage devices and/or networking devices may be considered peripheral equipment in some embodiments and part of a system 102 in other embodiments, depending on their detachability from the processor 110. Other computer systems not shown in FIG. 1 may interact in technological ways with the computer system 102 or with another system embodiment using one or more connections to a network 108 via network interface equipment, for example.

Each computer system 102 includes at least one processor 110. The computer system 102, like other suitable systems, also includes one or more computer-readable storage media 112. Storage media 112 may be of different physical types. The storage media 112 may be volatile memory, non-volatile memory, fixed in place media, removable media, magnetic media, optical media, solid-state media, and/or of other types of physical durable storage media (as opposed to merely a propagated signal or mere energy). In particular, a configured storage medium 114 such as a portable (i.e., external) hard drive, CD, DVD, memory stick, or other removable non-volatile memory medium may become functionally a technological part of the computer system when inserted or otherwise installed, making its content accessible for interaction with and use by processor 110. The removable configured storage medium 114 is an example of a computer-readable storage medium 112. Some other examples of computer-readable storage media 112 include built-in RAM, ROM, hard disks, and other memory storage devices which are not readily removable by users 104. For compliance with current United States patent requirements, neither a computer-readable medium nor a computer-readable storage medium nor a computer-readable memory is a signal per se or mere energy under any claim pending or granted in the United States.

The storage medium 114 is configured with binary instructions 116 that are executable by a processor 110; “executable” is used in a broad sense herein to include machine code, interpretable code, bytecode, and/or code that runs on a virtual machine, for example. The storage medium 114 is also configured with data 118 which is created, modified, referenced, and/or otherwise used for technical effect by execution of the instructions 116. The instructions 116 and the data 118 configure the memory or other storage medium 114 in which they reside; when that memory or other computer readable storage medium is a functional part of a given computer system, the instructions 116 and data 118 also configure that computer system. In some embodiments, a portion of the data 118 is representative of real-world items such as product characteristics, inventories, physical measurements, settings, images, readings, targets, volumes, and so forth. Such data is also transformed by backup, restore, commits, aborts, reformatting, and/or other technical operations.

A given operating environment 100 may include an Integrated Development Environment (IDE) 122 which provides a developer with a set of coordinated computing technology development tools 122 such as compilers, source code editors, profilers, debuggers, layout tools, simulators, and so on. In particular, some of the suitable operating environments for some software development embodiments include or help create a Microsoft® Visual Studio® development environment (marks of Microsoft Corporation) configured to support program development. Some suitable operating environments include Java® environments (mark of Oracle America, Inc.), and some include environments which utilize languages such as C++ or C# (“C-Sharp”), but many teachings herein are applicable with a wide variety of programming languages, programming models, and programs.

Although an embodiment may be described as being implemented as software instructions executed by one or more processors in a computing device (e.g., general purpose computer, server, or cluster), such description is not meant to exhaust all possible embodiments. One of skill will understand that the same or similar functionality can also often be implemented, in whole or in part, directly in hardware logic, to provide the same or similar technical effects. Alternatively, or in addition to software implementation, the technical functionality described herein can be performed, at least in part, by one or more hardware logic components. For example, and without excluding other implementations, an embodiment may include hardware logic components 110, 128 such as Field-Programmable Gate Arrays (FPGAs), Application-Specific Integrated Circuits (ASICs), Application-Specific Standard Products (ASSPs), System-on-a-Chip components (SOCs), Complex Programmable Logic Devices (CPLDs), and similar components. Components of an embodiment may be grouped into interacting functional modules based on their inputs, outputs, and/or their technical effects, for example.

In addition to processors 110 (e.g., CPUs, ALUs, FPUs, and/or GPUs), memory/storage media 112, and displays 126, an operating environment may also include other hardware 128, such as batteries, buses, power supplies, wired and wireless network interface cards, for instance. The nouns “screen” and “display” are used interchangeably herein. A display 126 may include one or more touch screens, screens responsive to input from a pen or tablet, or screens which operate solely for output. In some embodiments peripherals 106 such as human user I/O devices (screen, keyboard, mouse, tablet, microphone, speaker, motion sensor, etc.) will be present in operable communication with one or more processors 110 and memory. Software processes may be users 104, but unless clearly indicated otherwise, end-users are human.

In some embodiments, the system includes multiple computers connected by a network 108. Networking interface equipment 128 can provide access to networks 108, using components such as a packet-switched network interface card, a wireless transceiver, or a telephone network interface, for example, which may be present in a given computer system. However, an embodiment may also communicate technical data and/or technical instructions through direct memory access, removable nonvolatile storage media, or other information storage-retrieval and/or transmission approaches.

One of skill will appreciate that the foregoing aspects and other aspects presented herein under “Operating Environments” may form part of a given embodiment. This document's headings are not intended to provide a strict classification of features into embodiment and non-embodiment feature sets.

One or more items are shown in outline form in the Figures, or listed inside parentheses, to emphasize that they are not necessarily part of the illustrated operating environment or all embodiments, but may interoperate with items in the operating environment or some embodiments as discussed herein. It does not follow that items not in outline or parenthetical form are necessarily required, in any Figure or any embodiment. In particular, FIG. 1 is provided for convenience; inclusion of an item in FIG. 1 does not imply that the item, or the described use of the item, was known prior to the current innovations.

More about Systems

Examples are provided herein to help illustrate aspects of the technology, but the examples given within this document do not describe all of the possible embodiments. Embodiments are not limited to the specific implementations, arrangements, displays, features, approaches, or scenarios provided herein. A given embodiment may include additional or different technical features, mechanisms, sequences, or data structures, for instance, and may otherwise depart from the examples provided herein.

FIG. 2 illustrates aspects of some architectures suitable for embodiments taught herein. A developer system 202 communicates over one or more networks 108 with a tool extension market 204 and a tool extension recommendation backend system 216.

Communications between the developer system and the tool extension market may include queries 212 to the market and query results 214 from the market. For example, the developer system may specify keywords or tags to a market search interface 208 to find out, via query results, what tool extensions 210 matching the search criteria are currently available in the market. Tool extensions 210 can be installed on the developer system to extend the functionality of a developer tool 206.

Communications between the developer system and the tool extension recommendation backend system may include usage data 222 which tells telemetry code 218 on the backend what tool extensions are installed (or installed and used) on the developer system. The backend system has recommendation code 220, including top-extensions-by-context code 226 that creates or updates one or more top-extensions-by-context data structures 224, to compute and send tool extension recommendations 228 to the developer system. Recommendation code 220 may also run on the developer system, e.g., to extract tool extension names from a top-extensions-by-context data structure for display to a developer in a tool extension recommendation.

With reference to FIG. 3, a software development tool 300 includes a user interface portion, referred to here as a renderer 314, and also includes zero or more hosted tool extensions 210. The tool extensions are hosted by an extension host 302 portion of the development tool 300, via an extension API 304.

As indicated in FIG. 4 and with continued reference to FIG. 3, some additional development tool components may include a communications agent 402, programming language server(s) 306, debug adapters(s) 308, and other code 312. The connection between the renderer 314 and the agent 402 may be a network 108 connection, and may use one or more familiar network communication protocols such as TCP/IP, UDP, HTTPS, HTML, and so on. Extension host 302 communication with a debug adapter 308 may utilize a debug adapter protocol. Communication with a language server 306 may utilize a language server protocol.

As indicated in FIG. 4, the components of a development tool 300 may reside in two distinct machines. In this example architecture, the machine with the renderer 314 is referred to as the developer machine 404 because it is where the developer 104 interfaces directly with the development tool 300. The other machine(s) are each referred to as an extension machine 406 because the extension(s) 210 run on them. Thus, a filesystem 316 on the developer machine 404 (if such a filesystem is present) may be considered a “local” filesystem because it is local to the developer, whereas the filesystem on the extension machine 406 may be considered a “remote” filesystem because it is remote from the developer.

FIGS. 3 and 4 are examples, not a complete inventory of suitable development tool architectures. One of skill will acknowledge that teachings herein about obtaining and using tool extension recommendations may also be applied with other development tool architectures.

With reference to FIG. 5, a developer machine 404 and an extension machine 406 may each be a physical machine, or may be a virtual machine 502 running on underlying physical machine hardware 506 by way of at least a hypervisor 504. The hypervisor 504 may be a “bare metal” or type I hypervisor running directly on the hardware 506, or it may be a type II hypervisor which runs on a host operating system or another kernel that in turn runs directly on the hardware 506. Hardware 506 includes at least one processor 110 having one or more cores, and RAM or other working memory in operable communication with the processor(s) having a storage capacity. The physical machine(s) or virtual machine(s) may each be located in a public, private, hybrid, or community cloud, or not.

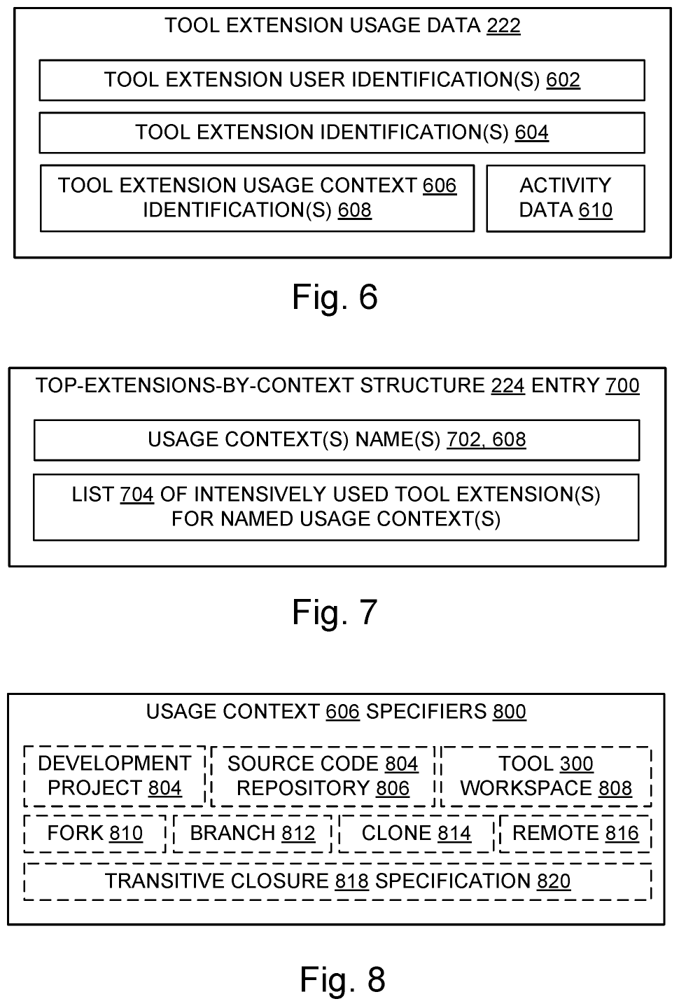

FIG. 6 illustrates aspects of toll extension usage data 222. This data may include tool extension user identifications 602, e.g., usernames, user email addresses, given names and surnames, or some combination thereof, identifying one or more developers who have used one or more tool extensions. Usage data may include tool extension identifications 604, e.g., extension names or nicknames, GUIDs, URIs, or extension download hyperlinks. Usage data may include extension usage context 606 identifications 608, e.g., project names, workspace names, repository IDs, and zero or more branch or form or clone or other qualifiers to such names and IDs. User session activity data 610 identifying what user performed what activities in what contexts 606 may be present in the usage data. Although for convenience FIG. 6 shows all items 602, 604, 608, 610 in solid lines, in a given implementation these items may be stored or transferred partly or entirely in separate data structures or communications.

FIG. 7 illustrates aspects of an entry 700 in a top-extensions-by-context data structure 224. The illustrated entry includes human-readable (e.g., ASCII or Unicode text) usage context names 702 which correspond to identifications 608 that are not necessarily human-readable (e.g., GUIDs, pointers, addresses, handles). The entry also includes a list 704 identifying tool extensions which have been or are currently being intensively used in named usage context(s). This list serves as a basis for recommending intensively used tool extensions to developer(s) who are in the named usage context(s).

FIG. 8 illustrates some specifiers 800 which define, constrain, locate, identify, or otherwise specify a tool extension usage context 606. Specifiers are shown in dashed form to indicate that in a given situation each individual specifier 800 shown in FIG. 8 may or may not be present or employed. The dashed lines are not meant to indicate that specifiers can be entirely omitted; it is expected that at least one specifier (either from the FIG. 8 examples or otherwise) will be employed in any given embodiment. The illustrated tool extension usage context specifiers include a development project 802 identifier, a repository 806 identifier, a tool workspace 808 identifier, a fork 810 identifier, a branch 812 identifier, a clone 814 identifier, a remote 816 identifier, and a transitive closure 818 identifier. Although not called out specifically, “copy of” is a default specifier 800, 820, which is present unless expressly ruled out; other specifiers are not part of a given transitive closure or usage context specification discussed herein unless their presence is expressly stated. Also, it is expected that the transitive closure 818 specifier will be present in many, if not all, implementations.

In mathematics, the term “transitive closure” is defined according to binary relations and transitivity. A “binary relation” on a set S is a set of ordered pairs of members of S. For example, “less than” is a binary relation on the set of integers, which includes (2, 5) and (3, 77) but does not include (10, 6), because 2 is less than 5, 3 is less than 77, and 10 is not less than 6. A binary relation is “transitive” if whenever x is related to y and y is related to z, then x is related to z. The binary relation “less than” is transitive; whenever x is less than y and y is less than z, x is also less than z. In mathematics, the “transitive closure” of a binary relation R on a set S is the smallest relation on S that includes R and is transitive. So for example, if S is a set of cities, and the relation R is such that x related to y means there is a flight from x to y, then the transitive closure of R is the set of cities one can fly to from some city in S.

In the present disclosure, by contrast, “transitive closure” is defined for a given situation based on usage context specifiers 800. For example, if p is a project 802, and the only specifier present is the default specifier “copy of”, then the transitive closure of p is p itself and all copies of p. But if the fork specifier 810 is also present, then the transitive closure of p is p itself, all copies of p, all forks of p, and all copies of forks of p. Unless all clones are specified, the transitive closure of a repository clone rc is rc itself, all copies of rc, the repository r from which rc was cloned, and all copies of r. If all first-level clones are specified, then the transitive closure would be the repository r, all copies of r, all clones of r, and all copies of clones of r. If all clones of any level removed from r are specified (or if no limit on the level of distance is specified) then the transitive closure would be the repository r, all copies of r, all clones of r, all copies of clones of r, all clones of a clone of r and copies thereof, all clones of a clone of a clone of r and copies thereof, and so on. Specifiers can also be combined, e.g., to include in a given transitive closure branches of forks, forks of branches, multiple projects, multiple repositories, multiple workspaces, a particular repository and a particular project, and so on. One of skill will recognize that although there are many possible ways to specify a transitive closure consistent with the teachings herein, there is no ambiguity because the transitive closure is the smallest set of tool extension usages (projects, workspaces, clones, etc.) that is supported by the usage data in question and by the stated specifier(s) plus the implicit “copy of” specifier. More generally, if X and Y are related under some relationship R, and Y and Z are related under R, then X and Y and Z will be consolidated together in the transitive closure under R.

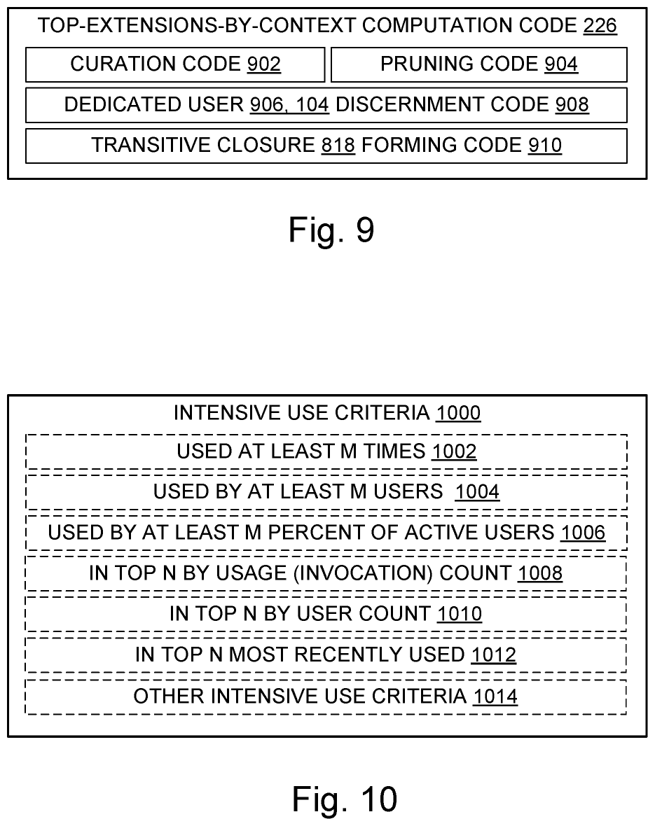

FIG. 9 shows some examples of top-extensions-by-context computation code 226. These include tool extension usage data curation code 902, tool extension usage data pruning code 904, dedicated user 906 discernment code 908, and transitive closure forming code 910.

In some embodiments, tool extension usage data curation code 902 executes one or more of the following computational operations: identifies dedicated users, for a given user finds out which remotes, clones, branches, or forks (or combination thereof) the user has been using in a given activity session or set of activity sessions, finds out which tool extension(s) a given user was using in a given activity session or set of activity sessions, joins usage context information (remotes, clones, branches, etc.) with tool extension information to find out which extensions have been used in which contexts in a given activity session or set of activity sessions, combines such information records for a single user across multiple activity sessions to create a summary record.

In some embodiments, tool extension usage data pruning code 904 executes one or more of the following computational operations: remove from consideration all usage context information (remotes, clones, branches, etc.) which have less than a minimum number of users. In particular, remotes used by only one user may be pruned out.

In some embodiments, tool extension usage data dedicated user 906 discernment code 908 executes one or more of the following computational operations: identify a dedicated user 906, remove from consideration all usage context information (remotes, clones, branches, etc.) which does not pertain to at least one dedicated user.

In some embodiments, transitive closure forming code 910 executes one or more of the following computational operations: calculate a transitive closure of all repositories, compute the frequency of extensions activated in those repositories, produce a set of remote IDs or repository IDs with the top 10% of extensions based on usage frequency, calculate a transitive closure of other usage contexts with other specifiers 800 (implicit in code, or explicitly stated in a configuration or settings file, for instance), compute the frequency of extensions activated in one or more of those usage contexts, produce a set of usage context IDs with the top N % of extensions based on usage frequency. To facilitate or provide protection of intellectual property rights, the transitive closure forming code 910 may reside on a proprietary backend system 216 and not be published as open source code, even if source codes of interoperable related items such as the development tool 206 and extensions 210 are published.

FIG. 10 illustrates intensive use criteria 1000 which, it is expected, will in practice be implicit in backend system recommendation code 220. These criteria may be explicitly stated to developers in recommendations 228, or not. A recommendation might simply indicate that the recommended tool extensions are being used by other developers, without expressly revealing the thresholds M, N or the kinds of data (e.g., use count, user count) that were used by the code 220 to select the extensions for inclusion in the recommendation.

Some embodiments use or provide a tool extension recommendation backend system 216 which includes a processor 110, a memory 112 in operable communication with the processor, tool extension usage data 222, and top-extensions-by-context computation code 226. The tool extension usage data includes at least the following: tool extension user identifications 602 which identify users of one or more tool extensions, tool extension identifications 604 which identify one or more tool extensions which have been used by one or more of the users, and tool extension usage context identifications 608 which identify usage contexts 606 in which tool extensions have been used by one or more of the users. Upon execution with the processor, the top-extensions-by-context computation code 226 computes a top-extensions-by-context structure 224 from at least part of the tool extension usage data. The top-extensions-by-context structure includes entries 700. Each entry names 702 a usage context and lists 704 one or more tool extensions which the top-extensions-by-context computation code determines have been used intensively in that usage context. In some embodiments, the computation code 226 is not triggered or activated by user request submitted on a developer machine, but instead runs periodically on a separate process on a backend system machine.

In some embodiments, recommendation code 220 upon execution with the processor transmits at least a portion of the top-extensions-by-context structure 224 onto a network connection toward at least one developer system. The top-extensions-by-context structure will configure the developer system for improved developer productivity by recommendation of intensively used tool extensions to a developer for use in a usage context that is named in the top-extensions-by-context structure, and currently in use or potentially in use by the developer. In some embodiments, recommendation code 220 interfaces with or controls the top-extensions-by-context computation code 226, e.g., to set criteria 1000 the code 226 uses to determine what qualifies as a “top” extension, e.g., an intensively used extension.

Some embodiments expressly includes both the developer system and the backend system. One such embodiment includes the tool extension recommendation backend system 216 in combination with a developer system 202. The developer system includes a developer system processor 110, a developer system memory 112 in operable communication with the developer system processor, and a tool 206 which configures the developer system memory and is extensible by at least one of the tool extensions 210 listed in the top-extensions-by-context structure 224.

In some embodiments, each usage context 606 corresponds to use of a tool extension 210 in one or more of the following: a particular development project 802, a fork 810 of a particular development project, a particular source code repository 806, a branch 812 of a particular source code repository, a clone 814 of a particular source code repository, or a workspace 808 in an extensible development tool. As an additional example, a usage context 606 could be defined with structural information about a workspace, e.g., a thumb print of a folder structure and of what file types are in which folder. Another usage context 606 characteristic might be what libraries a workspace depends on. A repository usage context may be relatively simple to implement, but is not the only example. A given project P1 may be structurally and semantically equivalent to a project P2 that is in a different repository. For example, both projects may build a React Native framework app that talks to a node server that uses a SQL data base and a Redis cache and provides authentication using passport.js. Given these (or similar, in other examples) structural and semantic equivalences, it would be appropriate to deem both projects P1 and P2 as belonging to the same usage context, and hence appropriate to make recommendations on the basis that both users of these projects would benefit from using the same extensions 210.

In some embodiments, the top-extensions-by-context computation code 226 includes curation code 902. Upon execution with the processor 110, the curation code 902 curates raw tool extension usage data 222 by combining usage data records for a given user 104 across multiple user activity sessions into a single usage data record.

In some embodiments, the top-extensions-by-context computation code 226 includes pruning code 904. Upon execution with the processor 110, the pruning code 904 removes tool extension usage data for one or more usage contexts that each have less than a specified minimum number of users. For example, in one embodiment the minimum is one, so the pruning code 904 removes usage data for all the remotes that are used by only one user. As to pruning, “removing” data means ignoring the data, e.g., not including it in a computation of the top-extensions-by-context structure 224. Removing data allows but does not require deleting the data.

In some embodiments, the top-extensions-by-context computation code 226 includes transitive-closure forming code 910 which upon execution with the processor forms through computation at least one of the following: a transitive closure 818 with respect to a source code repository and repository clones, a transitive closure 818 with respect to a source code repository and repository branches, a transitive closure 818 with respect to a source code repository branch and repository branch forks, or a transitive closure 818 with respect to a source code repository, branches, and forks.

In some embodiments, the top-extensions-by-context computation code 226 discerns dedicated users, namely, users who appear in the tool extension usage data at least a specified number of times over the course of a given time frame. In some cases, the top-extensions-by-context structure 224 does not rely on usage data of users who are not dedicated users.

In some embodiments, the top-extensions-by-context computation code 226 determines that a tool extension has been used intensively in a usage context based on one or more intensive use criteria 1000. One criterion 1000, 1002 is that the tool extension has been used in the usage context at least a predetermined number of times, e.g., used at least ten times in the project, or that the tool extension has been used in the usage context at least a predetermined number of times during a specified time period, e.g., used at least five times in the past two days. One criterion 1000, 1004 is that the tool extension has been used in the usage context by at least a predetermined number of different users, e.g., used by at least 250 users in the project. One criterion 1000, 1006 is that the tool extension has been used in the usage context by at least a predetermined percentage of users who have used at least one extension in the usage context, e.g., used by at least half of the users in the project. One criterion 1000, 1008 is that the tool extension has a usage count in the usage context which is in the top N usage counts for extensions used in the usage context, where N is a specified positive integer, e.g., one of the top 5 most frequently used extensions in the project. One embodiment treats as “top” extensions the top 10% of extensions in terms of their usage frequency.

Other system embodiments are also described herein, either directly or derivable as system versions of described methods or configured media, informed by the extension discussion herein of computing hardware.

Methods

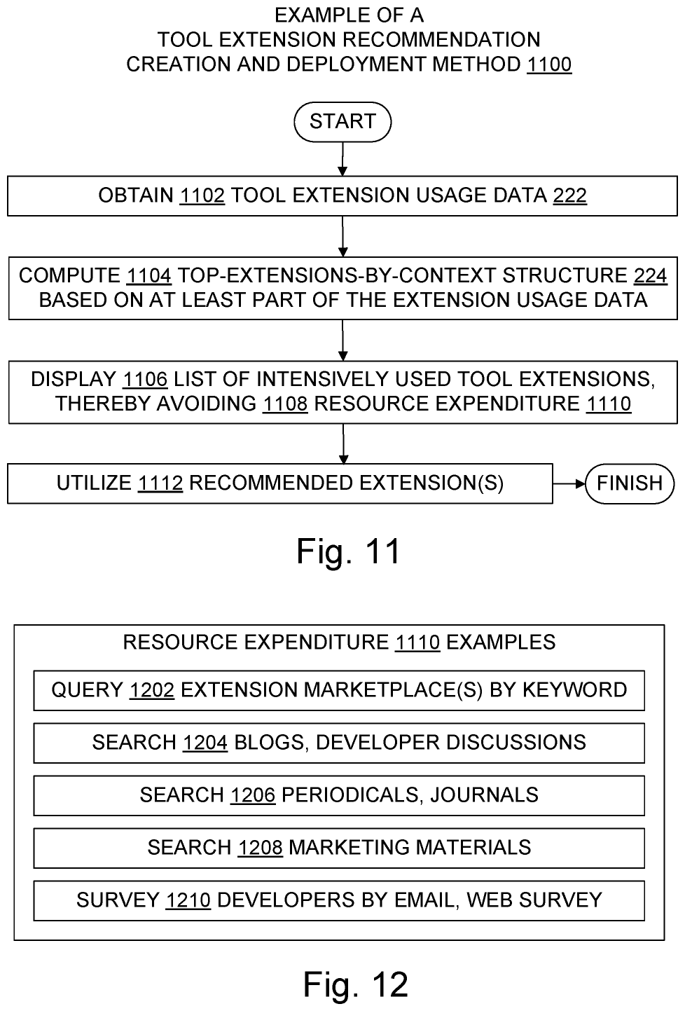

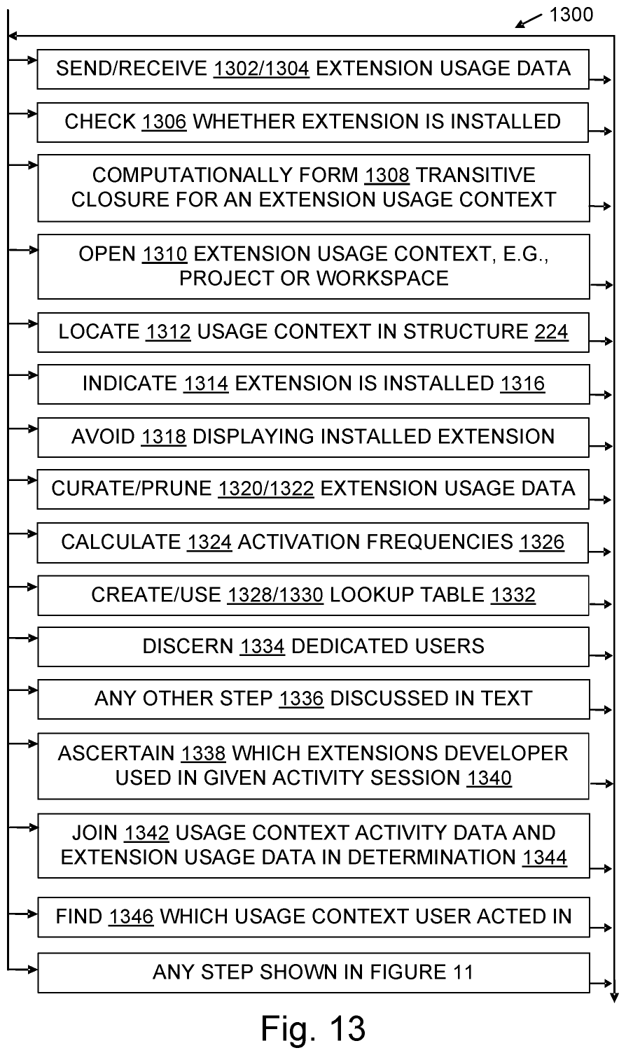

With particular reference to FIGS. 11 to 13, some embodiments provide or use a method for use in recommending a development tool extension. The method may include obtaining 1102 tool extension usage data 222, computing 1104 a top-extensions-by-context structure from at least part of the tool extension usage data, and displaying 1106 at least part of a list of one or more intensively used tool extensions to a developer in a recommendation for use in a usage context that is named in the top-extensions-by-context structure.

In some embodiments, the tool extension usage data 222 includes at least the following: (a) tool extension user identifications which identify users of one or more tool extensions, (b) tool extension identifications which identify one or more tool extensions which have been used by one or more of the users, and (c) tool extension usage context identifications which identify usage contexts in which tool extensions have been used by one or more of the users.

In some embodiments, the top-extensions-by-context structure includes entries 700, with each entry naming a usage context and listing one or more tool extensions which the top-extensions-by-context computation determines have been used intensively in that usage context.

In some embodiments, displaying 1106 intensively used tool extensions allows the developer to avoid 1108 expending 1110 developer time and developer system resources on an effort to discover extensions which have been used intensively in the developer's current usage context. FIG. 12 shows examples of expenditures 1110 that may be accordingly avoided 1108.

Some embodiments further include telemetry data collection, as seen from the developer system point of view or the backend system point of view, or both. That is, the method may include a developer system sending 1302 a portion of the tool extension usage data toward a tool extension recommendation backend system, or a tool extension recommendation backend system receiving 1304 a portion of the tool extension usage data sent from a developer system, or both steps 1302 and 1304.

Some embodiments are focused on repository clones, and in some of these computing the top-extensions-by-context structure includes computationally forming 1308 for one of the usage contexts a transitive closure 818 which consists substantially of a particular repository R and clones of R. As used here, the phrase “consists substantially of” means the transitive closure includes the repository R and its clones and does not include any other repository, but may include other data, e.g., metadata which identifies the repository users and the extensions used.

In some embodiments, a particular kind of act triggers the recommendation display 1106. For example, in some the method includes opening 1310 a project 802 at a developer system, and in response to opening the project locating 1312 an entry of the top-extensions-by-context structure whose usage context names the project and then displaying 1106 one or more intensively used tool extensions listed in the located entry. Other recommendation display triggers are also possible. In some VS Code environments, for instance, a recommendation may be displayed upon opening an extension panel.

Some embodiments check whether a tool extension has been installed before deciding whether to recommend it. Installed extensions may be omitted from the recommendation displayed, or they could be included but marked as “already installed”. That is, in some embodiments the method further includes checking 1306 whether a given intensively used tool extension is already installed 1316 on a developer system. When the given intensively used tool extension is already installed on the developer system, the method does one of the following: displays 1106 the installed intensively used tool extension in the recommendation together with an indication that it is already installed, or else does not display 1106 the installed intensively used tool extension in the recommendation.

Additional examples of usage context further illustrate the possible range of embodiments. In some embodiments, a usage context includes exactly one of the following: a particular development project, a particular development project and all identified forks of that development project, a particular source code repository, a particular source code repository and all identified branches of that source code repository, a particular source code repository and all identified clones of that source code repository, a particular source code repository and all identified forks of that source code repository, or a particular workspace in an extensible development tool. As used here, “identified” means identified in the obtained tool extension usage data.

In some embodiments, computing 1104 the top-extensions-by-context structure includes curating 1320 raw tool extension usage data by combining usage data records for a given user across multiple user activity sessions into a single usage data record. In some it alternately or additionally includes pruning 1322 tool extension usage data by determining whether a usage context has less than a specified minimum number of users. In some, it includes computationally forming 1308 a transitive closure for at least one usage context after the curating and pruning, while excluding from this transitive closure computation any pruned usage data.

In some embodiments, computing 1104 the top-extensions-by-context structure includes calculating 1324 extension activation frequencies 1326 for two or more tool extensions which have been activated in a usage context.

In some embodiments, computing 1104 the top-extensions-by-context structure includes creating 1328 a lookup table 1332 which includes usage contexts with corresponding intensively used tool extensions and user counts. Each user count indicates the number of users of the usage context identified in the tool extension usage data at a point prior to creating the lookup table.

Technical methods shown in the Figures or otherwise disclosed will be performed automatically, e.g., by a text editor process executing on a computer system, unless otherwise indicated. Methods may also be performed in part automatically and in part manually to the extent action by a human administrator or other human person is implicated, e.g., entering a command to open a workspace or project in an extensible development tool 206. No method contemplated as innovative herein is entirely manual. In a given embodiment zero or more illustrated steps of a method may be repeated, perhaps with different parameters or data to operate on. Steps in an embodiment may also be done in a different order than the top-to-bottom order that is laid out in FIGS. 11 and 13. Steps may be performed serially, in a partially overlapping manner, or fully in parallel. In particular, the order in which flowchart 1100 or flowchart 1300 is traversed to indicate the steps performed during a method may vary from one performance of the method to another performance of the method. The flowchart traversal order may also vary from one method embodiment to another method embodiment. Steps may also be omitted, combined, renamed, regrouped, be performed on one or more machines, or otherwise depart from the illustrated flow, provided that the method performed is operable and conforms to at least one claim.

Configured Storage Media

Some embodiments include a configured computer-readable storage medium 112. Storage medium 112 may include disks (magnetic, optical, or otherwise), RAM, EEPROMS or other ROMs, and/or other configurable memory, including in particular computer-readable storage media (which are not mere propagated signals). The storage medium which is configured may be in particular a removable storage medium 114 such as a CD, DVD, or flash memory. A general-purpose memory, which may be removable or not, and may be volatile or not, can be configured into an embodiment using items such as top-extensions-by-context code 226, top-extensions-by-context structures 224, recommendations 228, recommendation code 220, and telemetry data 222, in the form of data 118 and instructions 116, read from a removable storage medium 114 and/or another source such as a network connection, to form a configured storage medium. The configured storage medium 112 is capable of causing a computer system to perform technical process steps for recommending development tool extensions 210, as disclosed herein. The Figures thus help illustrate configured storage media embodiments and process embodiments, as well as system and process embodiments. In particular, any of the process steps illustrated in FIG. 11 or 13, or otherwise taught herein, may be used to help configure a storage medium to form a configured storage medium embodiment.

Some embodiments use or provide a storage medium 112, 114 configured with code which upon execution by one or more processors performs a method for recommending a development tool extension. This method includes computing 1104 a top-extensions-by-context structure from tool extension usage data. The top-extensions-by-context structure includes entries, each entry naming a usage context and listing one or more tool extensions which the top-extensions-by-context computation determines have been used intensively in that usage context. The tool extension usage data includes at least the following: (a) tool extension user identifications which identify users of one or more tool extensions, (b) tool extension identifications which identify one or more tool extensions which have been used by one or more of the users, and (c) tool extension usage context identifications which identify usage contexts in which tool extensions have been used by one or more of the users.

This method also includes displaying 1106 at least part of a list of one or more intensively used tool extensions in a recommendation for use in a usage context that is named in the top-extensions-by-context structure, thereby allowing a developer to avoid 1108 expending 1110 developer time and developer system resources on an effort to discover extensions which have been used intensively in the developer's current usage context.

In some embodiments, the method includes at least N of the following listed operations, where N is 2, 3, 4, 5, 6, 7, 8, or 9 depending on the embodiment: curating 1320 raw tool extension usage data by combining usage data records for a given user across multiple user activity sessions into a single usage data record; pruning 1322 tool extension usage data by determining whether a usage context has less than a specified minimum number of users, and then excluding from a transitive closure computation the usage data for any such usage context; discerning 1334 dedicated users, namely, users who appear in the tool extension usage data at least a specified number of times; finding 1346 which one or more usage contexts a user has been active in during a given activity session; ascertaining 1338 which one or more tool extensions a user has been using in a given activity session; joining 1342 usage context activity information and tool extension usage information to determine 1344 which tool extensions have been used in which usage contexts; computationally forming 1308 a transitive closure for at least one usage context; checking 1306 whether a given tool extension is already installed on a developer system; creating 1328 a lookup table which includes usage contexts with their corresponding intensively used tool extensions; or creating 1328 a lookup table which includes usage contexts with their corresponding intensively used tool extensions and user counts. In some embodiments, checking 1306 whether a given tool extension is already installed is done on the developer system 202 whereas all the other steps listed in this paragraph are done on the backend system 216.

Data Processing Example

To further illustrate aspects of some embodiments, an example using specific data values is now presented. These data values are mock values, but are realistic in that they show how specific data values would be processed and generated in an embodiment. They are not actual live production data.

More generally, one of skill will recognize that not every part of this disclosure, or any particular details therein, are necessarily required to satisfy legal criteria such as enablement, written description, or best mode. Also, embodiments are not limited to the particular programming languages, tool contexts, identifiers, fields, class definitions, or other implementation choices described herein. Any apparent conflict with any other patent disclosure, even from the owner of the present innovations, has no role in interpreting the claims presented in this patent disclosure.

Table 1 shows mock raw usage data 222 reflecting user engagement as it could occur in a VS Code environment.

TABLE 1

| VSCodeMachineID | RemotesExtensions |
|---|---|
| U1 | <[R1, R11],[E1,E2]>, <[R2],[E1,E2]>, |
| | <[R11],[E3,E4,E5]>, <[R10, R2],[E1,E2,E3]> |
| U2 | <[R3],[E6]>, <[R1],[E3,E4]>, <[R5],[E6]>, |
| | <[R6],[E3]> |
| U3 | <[R5],[E6,E8,E9]>, <[R12],[E10,E11]>, |
| | <[R1],[E2,E8]> |
| . . . | . . . |

Table 2 shows the Table 1 data processed by curation code 902. In this example, in curation the records for a given person are consolidated based on the transitive closure of repositories.

TABLE 2

| ID | RemotesExtensions |
|---|---|
| U1 | <[R1,R11],[E1,E2,E3,E4,E5]>, <[R2,R10],[E1,E2,E3]> |
| U2 | <[R3],[E6]>, <[R1],[E3,E4]>, <[R5],[E6]>, <[R6],[E3]> |
| U3 | <[R5],[E6,E8,E9]>, <[R12],[E10,E11]>, <[R1],[E2,E8]> |
| . . . | . . . |

Tables 3 and 4 illustrate pruning 1322. The items shown in bold in Table 3 will be pruned (removed from further computation of the intensively used extensions) because their remotes R3, R6, R12 were each used by only one user. Although the portion of the data shown here has R2 only once, R2 is not pruned because it (by assumption) appears elsewhere in the data; not all data is shown here. Similar reasoning applies to R10 and R11.

TABLE 3

| ID | RemotesExtensions |
|---|---|
| U1 | <[R1,R11],[E1,E2,E3,E4,E5]>, <[R2,R10],[E1,E2,E3]> |
| U2 | <[R3],[E6]>, <[R1],[E3,E4]>, <[R5],[E6]>, <[R6],[E3]> |
| U3 | <[R5],[E6,E8,E9]>, <[R12],[E10,E11]>, <[R1],[E2,E8]> |
| . . . | . . . |

Table 4 shows the result of pruning 1322.

TABLE 4

| ID | RemotesExtensions |
|---|---|
| U1 | <[R1,R11],[E1,E2,E3,E4,E5]>, <[R2,R10],[E1,E2,E3]> |
| U2 | <[R1],[E3,E4]>, <[R5],[E6]> |
| U3 | <[R5],[E6,E8,E9]>, <[R1],[E2,E8]> |
| . . . | . . . |

Table 5 shows a result of calculating 1324 activation frequencies.

TABLE 5

| Remote | TopExtensions | UserCount |
|---|---|---|
| R1, R11 | E2, E3, E4 | 3 |
| R5 | E6 | 2 |
| . . . | . . . | |

Table 6 shows a lookup table 1332.

TABLE 6

| Remote | TopExtensions | UserCount |
|---|---|---|
| R1 | E2, E3, E4 | 3 |
| R11 | E2, E3, E4 | 3 |
| R5 | E6 | 2 |
| . . . | . . . | |

### Some Additional Combinations and Variations

Any of these combinations of code, data structures, logic, components, communications, and/or their functional equivalents may also be combined with any of the systems and their variations described above. A process may include any steps described herein in any subset or combination or sequence which is operable. Each variant may occur alone, or in combination with any one or more of the other variants. Each variant may occur with any of the processes and each process may be combined with any one or more of the other processes. Each process or combination of processes, including variants, may be combined with any of the configured storage medium combinations and variants describe above.

### CONCLUSION

In short, with the benefit of teachings provided herein, extensions 210 to add functionality to an extensible computing technology development tool 206 are identified and recommended to developers based at least in part on which tool extensions are being intensively used by developers working in the same or similar usage contexts 606. Usage contexts are specified 800 in terms of projects, workspaces, repositories, and optionally their branches, forks, clones, or remotes. Telemetry data 222 voluntarily provided from developer systems 202 is gathered and processed at a backend system 216 to produce a structure 224 listing some top (in terms of use) tool extensions. This structure is then provided to developer systems, where it serves as a basis for automatically recommending 228 top tool extensions to developers at appropriate points, e.g., when a developer opens a project or a workspace. This automated recommendation feature relieves developers of the burden 1110 of researching extensions to try and choose the ones that are most likely to help them efficiently and effectively develop implementations of computing technology.

Although particular embodiments are expressly illustrated and described herein as processes, as configured storage media, or as systems, it will be appreciated that discussion of one type of embodiment also generally extends to other embodiment types. For instance, the descriptions of processes in connection with FIGS. 11 and 13 also help describe configured storage media, and help describe the technical effects and operation of systems and manufactures like those discussed in connection with other Figures. It does not follow that limitations from one embodiment are necessarily read into another. In particular, processes are not necessarily limited to the data structures and arrangements presented while discussing systems or manufactures such as configured memories.

Those of skill will understand that implementation details may pertain to specific code, such as specific APIs, specific fields, and specific sample programs, and thus need not appear in every embodiment. Those of skill will also understand that program identifiers and some other terminology used in discussing details are implementation-specific and thus need not pertain to every embodiment. Nonetheless, although they are not necessarily required to be present here, such details may help some readers by providing context and/or may illustrate a few of the many possible implementations of the technology discussed herein.

Reference herein to an embodiment having some feature X and reference elsewhere herein to an embodiment having some feature Y does not exclude from this disclosure embodiments which have both feature X and feature Y, unless such exclusion is expressly stated herein. All possible negative claim limitations are within the scope of this disclosure, in the sense that any feature which is stated to be part of an embodiment may also be expressly removed from inclusion in another embodiment, even if that specific exclusion is not given in any example herein. The term “embodiment” is merely used herein as a more convenient form of “process, system, article of manufacture, configured computer readable storage medium, and/or other example of the teachings herein as applied in a manner consistent with applicable law.” Accordingly, a given “embodiment” may include any combination of features disclosed herein, provided the embodiment is consistent with at least one claim.

Not every item shown in the Figures need be present in every embodiment. Conversely, an embodiment may contain item(s) not shown expressly in the Figures. Although some possibilities are illustrated here in text and drawings by specific examples, embodiments may depart from these examples. For instance, specific technical effects or technical features of an example may be omitted, renamed, grouped differently, repeated, instantiated in hardware and/or software differently, or be a mix of effects or features appearing in two or more of the examples. Functionality shown at one location may also be provided at a different location in some embodiments; one of skill recognizes that functionality modules can be defined in various ways in a given implementation without necessarily omitting desired technical effects from the collection of interacting modules viewed as a whole.

Reference has been made to the figures throughout by reference numerals. Any apparent inconsistencies in the phrasing associated with a given reference numeral, in the figures or in the text, should be understood as simply broadening the scope of what is referenced by that numeral. Different instances of a given reference numeral may refer to different embodiments, even though the same reference numeral is used. Similarly, a given reference numeral may be used to refer to a verb, a noun, and/or to corresponding instances of each, e.g., a processor 110 may process 110 instructions by executing them.

As used herein, terms such as “a” and “the” are inclusive of one or more of the indicated item or step. In particular, in the claims a reference to an item generally means at least one such item is present and a reference to a step means at least one instance of the step is performed.

Headings are for convenience only; information on a given topic may be found outside the section whose heading indicates that topic.

All claims and the abstract, as filed, are part of the specification.

While exemplary embodiments have been shown in the drawings and described above, it will be apparent to those of ordinary skill in the art that numerous modifications can be made without departing from the principles and concepts set forth in the claims, and that such modifications need not encompass an entire abstract concept. Although the subject matter is described in language specific to structural features and/or procedural acts, it is to be understood that the subject matter defined in the appended claims is not necessarily limited to the specific technical features or acts described above the claims. It is not necessary for every means or aspect or technical effect identified in a given definition or example to be present or to be utilized in every embodiment. Rather, the specific features and acts and effects described are disclosed as examples for consideration when implementing the claims.

All changes which fall short of enveloping an entire abstract idea but come within the meaning and range of equivalency of the claims are to be embraced within their scope to the full extent permitted by law.

What is claimed is:

1. A tool extension recommendation backend system, comprising:
a processor;
a memory in operable communication with the processor;
tool extension usage data which includes at least the following: (a) tool extension user identifications which identify users of one or more tool extensions, (b) tool extension identifications which identify one or more tool extensions which have been used by one or more of the users, and (c) tool extension usage context identifications which identify usage contexts in which tool extensions have been used by one or more of the users;
top-extensions-by-context computation code which upon execution with the processor computes a top-extensions-by-context structure from at least part of the tool extension usage data, the top-extensions-by-context structure including entries, each entry naming a usage context and listing one or more tool extensions which the top-extensions-by-context computation code determines have been used intensively in that usage context; and
recommendation code which upon execution with the processor transmits at least a portion of the top-extensions-by-context structure onto a network connection toward at least one developer system, whereby the top-extensions-by-context structure will configure the developer system for improved developer productivity by recommendation of intensively used tool extensions to a developer for use in a usage context that is named in the top-extensions-by-context structure.

2. The tool extension recommendation backend system of claim 1, in combination with the developer system, wherein the developer system comprises a developer system processor, a developer system memory in operable communication with the developer system processor, and a tool which configures the developer system memory and is extensible by at least one of the tool extensions listed in the top-extensions-by-context structure.

3. The tool extension recommendation backend system of claim 1, wherein each usage context corresponds to use of a tool extension in one or more of the following:
a particular development project;
a fork of a particular development project;
a particular source code repository;
a branch of a particular source code repository;
a clone of a particular source code repository; or
a workspace in an extensible development tool.

4. The tool extension recommendation backend system of claim 1, wherein the top-extensions-by-context computation code comprises curation code, which upon execution with the processor curates raw tool extension usage data by combining usage data records for a given user across multiple user activity sessions into a single usage data record.

5. The tool extension recommendation backend system of claim 1, wherein the top-extensions-by-context computation code comprises pruning code, which upon execution with the processor removes tool extension usage data for one or more usage contexts that each have less than a specified minimum number of users.

6. The tool extension recommendation backend system of claim 1, wherein the top-extensions-by-context computation code comprises transitive-closure code which upon execution with the processor forms through computation at least one of the following:
a transitive closure with respect to a source code repository and repository clones;
a transitive closure with respect to a source code repository and repository branches;
a transitive closure with respect to a source code repository branch and repository branch forks; or
a transitive closure with respect to a source code repository, branches, and forks.

7. The tool extension recommendation backend system of claim 1, wherein the top-extensions-by-context computation code discerns dedicated users, namely, users who appear in the tool extension usage data at least a specified number of times, and wherein the top-extensions-by-context structure does not rely on usage data of users who are not dedicated users.

8. The tool extension recommendation backend system of claim 1, wherein the top-extensions-by-context computation code determines that a tool extension has been used intensively in a usage context based on one or more of the following intensive use criteria:
the tool extension has been used in the usage context at least a predetermined number of times;
the tool extension has been used in the usage context at least a predetermined number of times during a specified time period;
the tool extension has been used in the usage context by at least a predetermined number of different users;
the tool extension has been used in the usage context by at least a predetermined percentage of users who have used at least one extension in the usage context;
or
the tool extension has a usage count in the usage context which is in the top N usage counts for extensions used in the usage context, where N is a specified positive integer.

9. A method for recommending a development tool extension, comprising:
obtaining tool extension usage data which includes at least the following: (a) tool extension user identifications which identify users of one or more tool extensions, (b) tool extension identifications which identify one or more tool extensions which have been used by one or more of the users, and (c) tool extension usage context identifications which identify usage contexts in which tool extensions have been used by one or more of the users;
computing a top-extensions-by-context structure from at least part of the tool extension usage data, the top-extensions-by-context structure including entries, each entry naming a usage context and listing one or more tool extensions which the top-extensions-by-context computation determines have been used intensively in that usage context; and
displaying at least part of a list of one or more intensively used tool extensions to a developer in a recommendation for use in a usage context that is named in the top-extensions-by-context structure, thereby allowing the developer to avoid expending developer time and developer system resources on an effort to discover extensions which have been used intensively in the developer's current usage context.

10. The method of claim 9, further comprising at least one of the following:
a developer system sending a portion of the tool extension usage data toward a tool extension recommendation backend system; or
a tool extension recommendation backend system receiving a portion of the tool extension usage data sent from a developer system.

11. The method of claim 9, wherein computing the top-extensions-by-context structure comprises computationally forming for one of the usage contexts a transitive closure which consists substantially of a particular repository R and clones of R.

12. The method of claim 9, further comprising opening a project at a developer system, and in response to opening the project locating an entry of the top-extensions-by-context structure whose usage context names the project and then displaying one or more intensively used tool extensions listed in the located entry.

13. The method of claim 9, further comprising checking whether a given intensively used tool extension is already installed on a developer system, and when the given intensively used tool extension is already installed on the developer system doing one of the following:
displaying the installed intensively used tool extension in the recommendation together with an indication that it is already installed; or else
not displaying the installed intensively used tool extension in the recommendation.

14. The method of claim 9, wherein “identified” means identified in the obtained tool extension usage data, and wherein each usage context includes exactly one of the following:
a particular development project;
a particular development project and all identified forks of that development project;
a particular source code repository;
a particular source code repository and all identified branches of that source code repository;
a particular source code repository and all identified clones of that source code repository;
a particular source code repository and all identified forks of that source code repository; or
a particular workspace in an extensible development tool.

15. The method of claim 9, wherein computing the top-extensions-by-context structure comprises:
curating raw tool extension usage data by combining usage data records for a given user across multiple user activity sessions into a single usage data record;
pruning tool extension usage data by determining whether a usage context has less than a specified minimum number of users; and
computationally forming a transitive closure for at least one usage context after the curating and pruning, while excluding from this transitive closure computation any pruned usage data.

16. The method of claim 9, wherein computing the top-extensions-by-context structure comprises calculating extension activation frequencies for two or more tool extensions which have been activated in a usage context.

17. The method of claim 9, wherein computing the top-extensions-by-context structure comprises creating a lookup table which includes usage contexts with corresponding intensively used tool extensions and user counts, wherein each user count indicates the number of users of the usage context identified in the tool extension usage data at a point prior to creating the lookup table.

18. A storage medium configured with code which upon execution by one or more processors performs a method for recommending a development tool extension, the method comprising:
computing a top-extensions-by-context structure from tool extension usage data, the top-extensions-by-context structure including entries, each entry naming a usage context and listing one or more tool extensions which the top-extensions-by-context computation determines have been used intensively in that usage context, the tool extension usage data including at least the following: (a) tool extension user identifications which identify users of one or more tool extensions, (b) tool extension identifications which identify one or more tool extensions which have been used by one or more of the users, and (c) tool extension usage context identifications which identify usage contexts in which tool extensions have been used by one or more of the users; and
displaying at least part of a list of one or more intensively used tool extensions in a recommendation for use in a usage context that is named in the top-extensions-by-context structure, thereby allowing a developer to avoid expending developer time and developer system resources on an effort to discover extensions which have been used intensively in the developer's current usage context.

19. The storage medium of claim 18, wherein the method comprises at least three of the following listed operations:
curating raw tool extension usage data by combining usage data records for a given user across multiple user activity sessions into a single usage data record;
pruning tool extension usage data by determining whether a usage context has less than a specified minimum number of users, and then excluding from a transitive closure computation the usage data for any such usage context;
discerning dedicated users, namely, users who appear in the tool extension usage data at least a specified number of times;
finding which one or more usage contexts a user has been active in during a given activity session;
ascertaining which one or more tool extensions a user has been using in a given activity session;
joining usage context activity information and tool extension usage information to determine which tool extensions have been used in which usage contexts;
computationally forming a transitive closure for at least one usage context;
checking whether a given tool extension is already installed on a developer system;
creating a lookup table which includes usage contexts with their corresponding intensively used tool extensions; or
creating a lookup table which includes usage contexts with their corresponding intensively used tool extensions and user counts.

20. The storage medium of claim 19, wherein the method comprises at least five of the listed operations.
